(19) United States
(12) Patent Application Publication
(10) Pub. No.: US 2024/0079900 A1
(43) Pub. Date: Mar. 7, 2024

(54) OPTIMIZED BATTERY CHARGING CIRCUIT WITH POWER FACTOR CORRECTION

(71) Applicant: Iontra Inc, Centennial, CO (US)

(72) Inventor: David KESSNER, Denver, CO (US)

(21) Appl. No.: 18/240,967

(22) Filed: Aug. 31, 2023

Related U.S. Application Data
(60) Provisional application No. 63/403,182, filed on Sep. 1, 2022.

(51) Int. Cl. H02J 7/34; H02J 7/00; H02M 1/42; H02M 3/335; H02M 7/219

(52) U.S. Cl. CPC H02J 7/345; H02J 7/00711; H02M 1/4208; H02M 3/33507; H02M 7/219; H02J 2207/20

(57) ABSTRACT

An optimized charge signal shaping circuit is presented such that components of the charge signal circuit arrangement may be operable with fewer components and/or processing overhead than other approaches, thereby reducing costs, using less printed circuit board (PCB) real estate, and being computationally less complicated, among other advantages. In one particular implementation, portions of a power supply circuit may be combined with portions of a charge signal shaping circuit to leverage common functions and component characteristics of the portions, including a direct current/direct current (DC/DC) converter circuit. A reduced charge circuit may take advantage of each component including similar functions and/or circuit devices to reduce the overall number of components used in the charge circuit to reduce the overall footprint, conserve charging energy lost to the redundant components, and reduce the overall cost.

### CROSS-REFERENCE TO RELATED APPLICATION

This application is related to and claims priority under 35 U.S.C. § 119(e) from U.S. Patent Application No. 63/403,182, filed Sep. 1, 2022, titled “Optimized Battery Charging Circuit with Power Factor Correction,” the entire contents of which is incorporated herein by reference for all purposes.

### TECHNICAL FIELD

Embodiments of the present invention generally relate to systems and methods for charging or discharging a battery, and more specifically for an optimized circuit for generation of a tunable and/or high-efficiency charging signal to charge a battery.

### BACKGROUND AND INTRODUCTION

Countless different types of electrically powered devices, such as power tools, mobile computing and communication devices, portable electronic devices, and electrically powered vehicles, use rechargeable batteries as a source of operating power. Rechargeable batteries are limited by finite battery capacity and must be recharged upon depletion. Recharging a battery may be inconvenient as the powered device must often be stationary during the time required for recharging the battery and, depending on battery size, recharging can take hours. Moreover, battery charging is often accompanied by degradation of battery performance. As such, significant effort has been put into developing battery charging technology to reduce the time needed to recharge the battery, improve battery performance, and reduce degradation of the battery from charging, among other things.

Rapid recharging systems typically require costly high-power electronics for the delivery of high levels of charging current, along with current limit and overvoltage circuitry for preventing over-charging and resulting damage to the working battery. Thus, reducing the number of components in a charging circuit may significantly reduce the cost for producing and operating a charger. Moreover and importantly, higher current fast charging solutions can damage the battery particularly as the percentage of battery charge increases, and high current fast charging must often be limited as the percentage increases past about 50%. Slower recharging systems are less costly, but prolong the recharging operation, undermining the basic objective of a quick return to service.

It is with these observations in mind, among others, that aspects of the present disclosure were conceived and developed.

### SUMMARY

One aspect of the present disclosure relates to a system of charging a battery. The system may include a power supply circuit comprising a converter portion receiving a power signal and a voltage booster portion, a storage capacitor in operable communication with an output of the booster portion of the power supply circuit, the storage capacitor and power supply circuit correcting for a power factor loss of the power signal during charging of an electrochemical device and a combined direct current/direct current (DC/DC) converter and charge waveform shaping circuit to alter a DC signal from the booster portion to a shaped charge waveform for charging an electrochemical device.

Another aspect of the present disclosure relates to a method for charging a battery. The method comprises the operation of correcting, at a power supply circuit, a power factor of an alternating current (AC) component of an input power signal, converting, at the power supply circuit, the AC component of the input power signal into a direct current (DC) power signal, and controlling a switch in communication with a processor executing instructions to generate a control signal, the switch operable connected to a transformer to receive and alter the DC power signal to produce a shaped charge waveform to charge an electrochemical device.

Yet another aspect of the present disclosure relates to a charging circuit. The charging circuit may include a power supply converting an alternating current (AC) power signal to a direct current (DC) input signal, a transformer comprising a first end in electrical communication with the power supply and receiving the DC input signal, and a switch in electrical communication with a second end of the transformer. The charging circuit may also include a processor executing instructions to control the switch to pull the DC input signal through the transformer, wherein an output of the transformer provides a shaped charge waveform to charge an electrochemical device based on the control of the switch.

### BRIEF DESCRIPTION OF THE DRAWINGS

The various objects, features, and advantages of the present disclosure set forth herein will be apparent from the following description of embodiments of those inventive concepts, as illustrated in the accompanying drawings. It should be noted that the drawings are not necessarily to scale and may be representative of various features of an embodiment, the emphasis being placed on illustrating the principles and other aspects of the inventive concepts. Also, in the drawings the like reference characters may refer to the same parts or similar throughout the different views. It is intended that the embodiments and figures disclosed herein are to be considered illustrative rather than limiting.

FIG. 1 is a first schematic diagram of a charging circuit for charging or discharging a battery.

FIG. 2 is a second schematic diagram of the charging circuit illustrating components and systems of a power supply.

FIG. 3 is a schematic diagram of a charging circuit that includes a signal shaping generator and circuit model.

FIG. 4 is a first schematic diagram of a charging circuit with a combined converter and charge signal circuit.

FIG. 5 is a second schematic diagram of a charging circuit with a combined converter and charge signal circuit.

FIG. 6 is a diagram illustrating an example of a computing system which may be used in implementing embodiments of the present disclosure.

### DETAILED DESCRIPTION

Systems, methods, and devices for charging a battery or battery system is disclosed herein. The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery, increasing the available power of the battery with each stacked unit. Although many examples are discussed herein as applicable to a battery, it should be appreciated that the systems and methods described may apply to many different types of batteries ranging from an individual cell to batteries involving different possible interconnections of cells such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of lithium batteries including but not limited to lithium-metal and lithium-ion batteries, lead-acid batteries, various types of nickel batteries, and solid-state batteries of various possible chemistries, to name a few. The various implementations discussed herein may also apply to different structural battery arrangements such as button or “coin” type batteries, cylindrical battery cells, pouch battery cells, and prismatic battery cells.

In one example, the various embodiments discussed herein charge a battery by generating a charge signal that is controllably shaped by a charge signal shaping circuit. Conventional charge techniques, like constant current constant voltage (CCCV), do not involve charge signal shaping and may include frequencies or harmonics that degrade the battery performance over time, in addition to being inefficient in charging the battery. Aspects of the present disclosure, therefore, may include a shaped charge signal corresponding to a harmonic (or harmonics) associated with an optimal transfer of energy to the battery, although the purpose of the system is to be able to efficiently generate any arbitrarily shaped charging signal and apply the same to the battery, among other goals. In some instances, the charge signal shaping circuit may include a controller generating control signals to the components of the charge signal shaping circuit to shape or otherwise alter a charge signal. Said controller may include, in some implementations, a model of one or more components of a charge signal shaping circuit. The model may be used to confirm and/or adjust the controls for generating the signal based on an expected or intended charge signal for charging a battery.

Moreover, aspects of the charge signal shaping circuit discussed herein may be optimized such that components of the charge signal circuit arrangement may be operable with fewer components and/or processing overhead than other approaches, thereby reducing costs, using less printed circuit board (PCB) real estate, and being computationally less complicated, among other advantages. In one particular implementation, portions of a power supply circuit may be combined with portions of a charge signal shaping circuit to leverage common functions and component characteristics of the portions. For example, a charge circuit may include a typical power supply and a charge signal shaping circuit, both of which may include a direct current/direct current (DC/DC) converter circuit. Thus, a reduced charge circuit may take advantage of each component including similar functions and/or circuit devices to reduce the overall number of components used in the charge circuit. By separating the DC/DC converter from the power supply and combining similar components and functionalities with portions of the charge signal shaping circuit, significant reduction in the number of components of the charge circuit may be obtained. This reduction in the circuit design and/or components may reduce the overall footprint, conserve charging energy lost to the redundant components, and lessen the cost of the charge circuit while providing the same charging benefits and functionalities of the previous circuits.

In general, power factor (PF) is a ratio of real power (i.e., working power) to apparent power (i.e., demand) and is a number between 0 and 1 with higher numbers indicating better energy efficiency. A power factor value of 1 indicates that current and voltage are perfectly in phase; values less than 1 indicate some degree of phase misalignment and reduced energy efficiency in the system. Power factor correction circuits with capacitors, inductors, and/or other components can be designed to correct systems with poor power factor (e.g., PF<0.95 or PF<0.85). These circuits aim to bring current and voltage into phase alignment so that PF is near 1.

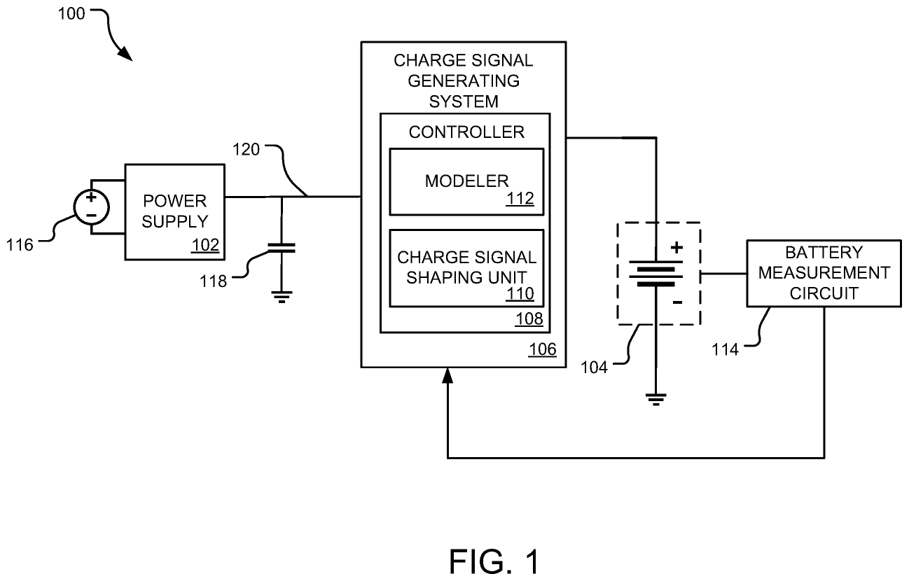

FIG. 1 is a schematic diagram illustrating an example charge signal generator arrangement 100 for recharging a battery 104. In general, a charge signal generating system 106 may be operably coupled between a power source 116/a power supply circuit 102 and a battery 104 to shape input power from the power supply into a charging signal for the battery. The charge signal generating system 106 may include, in some implementations, a controller 108, such as a microcontroller, FPGA (field-programmable gate array), ASIC (application-specific integrated circuit), microprocessor, state machine, combinations thereof, or other processing arrangement, that produces controls to a charge signal shaping unit 110 for generating a charge signal. The charge signal shaping unit 110 may be included within the controller 108. In some instances, the controller 108 may also include or may be in communication with a model or modeler 112 of components of the charge signal shaping unit or other components of the arrangement 100 to produce the control instructions to the charge signal shaping unit 110, although the modeler is not required. The charge signal generating system 106, including the controller 108 and/or modeler 112, may be an integrated unit. The charge signal generating system 106 may, in some implementations, receive battery measurements from a battery measurement circuit 114, such as current and/or voltage measurements at battery terminals of the battery 104 in the presence of a charge signal or calibration signal or otherwise. Those battery measurements may be used by the charge signal generating system 106 to calibrate or adjust the model of the modeler 112 or otherwise affect charge signal generation and/or control.

The power source 116 of the charging arrangement 100 may be a voltage source or a current source and, in some embodiments, may be an alternating current (AC) source. In general, the power source 116 provides energy to the power supply circuit 102. The power supply circuit 102, as explained in greater detail below, may convert the AC source signal into a DC signal transmitted to the charge signal generating system 106 via energy bus 120. In general, the power supply 102 supplies the charge energy, e.g., current, that may be shaped by the charge signal generating system 106 to produce a controllably shaped charge signal to charge the battery 104. A capacitor 118 or other energy storage device may also be connected to the energy bus 120. The capacitor 118 may store energy from the power supply 102 and provide the stored energy to the charge signal generating system 106 to maintain the DC energy signal during times in which power is not supplied by the power supply.

In some instances, the charge signal shaping circuit 110 may alter energy from the power supply 102 to generate a charge signal that is shaped based on charge conditions at the battery 104. For example, a charge signal shaping circuit 110 may generate a charge signal that at least partially corresponds to a harmonic or harmonics associated with an impedance of the battery when applied to the battery. In the example of FIG. 1 and otherwise, the circuit 100 may include a battery measurement circuit 114 connected to the battery 104 to measure battery cell voltage and/or charge current, as well as other battery attributes like temperature. The battery measurement circuit 114 may also measure or calculate the impedance the battery 104. In one example, battery characteristics may be measured based on the applied charge signal provided by the charge signal generating system 106. In another example, battery cell characteristics may be measured as part of a routine that applies a test signal with varying frequency attributes to the battery cell to generate a range of battery characteristic values (e.g., measured battery characteristic values such as temperature, current, voltage, or generated battery characteristic values such as impedance, etc.) associated with the different frequency attributes to characterize the battery. Signal frequencies associated with minimum and/or low battery impedance values may be identified and may be used to generate or modify a shape of the charge signal. This characterization routine may be done prior to charging, during charging, periodically during charging, in response to a predetermined trigger, and/or may be used in combination with look-up techniques, and other techniques to select or modify a desired charge signal. The battery characteristics obtained by the battery measurement circuit 114 may vary based on many physical or chemical features of the battery, including a state of charge and/or a temperature of the battery. As such, the battery measurement circuit 114 may be controlled by the charge signal generating system 106 to determine various battery characteristic values of the battery 104 during recharging of the battery, among other times, and provide the measurement of battery characteristic values to the circuit controller 108 or other parts of the charge signal generating system 106 for use in generating a shaped charge signal for charging the battery cell 104.

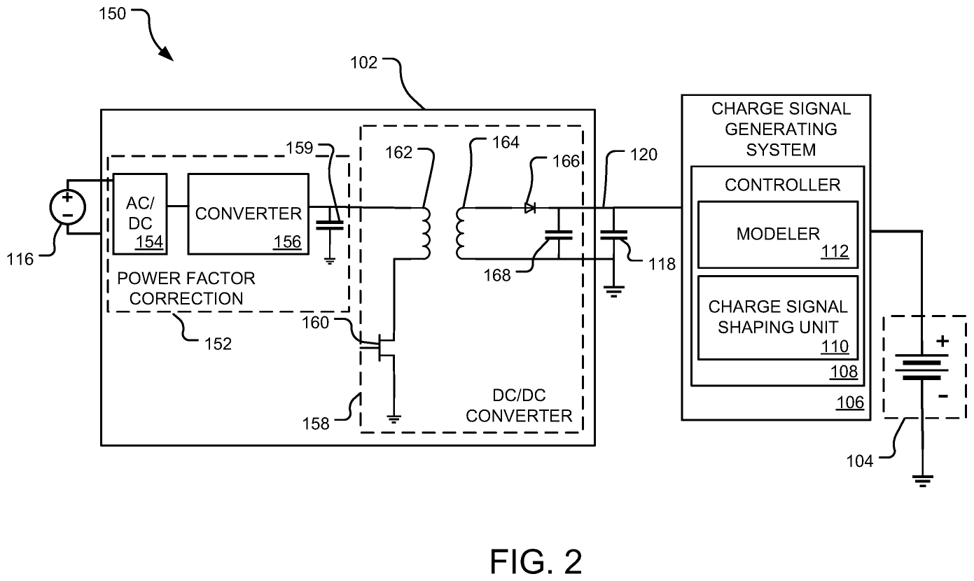

As mentioned above, the power supply 102 circuit may receive energy from power source 116 and output a DC power signal, among other possible output power signals, to energy bus 120. FIG. 2 is a second schematic diagram 150 of the charging circuit discussed above that illustrates components, circuits, portions, and/or systems of a power supply 102. As above, the charging circuit 150 may include the power source 116 connected to the power supply circuit 102 configured to provide an energy signal to energy bus 120. A charge signal generating system 106 as also discussed above may be in operable communication with the energy bus 120 to alter energy from the bus and generate a charge signal that is shaped based on one or more charge conditions at the battery 104. As above, a storage capacitor 118 may also be connected to the energy bus 120 to store energy from the power supply 102 and provide said energy to charge signal generating system 106 during down times of the power supply.

The circuit 150 of FIG. 2 illustrates various components of the power supply 102 circuit. In particular, the power supply 102 may include a power factor correction (PFC) circuit (illustrated as dashed box 152) and a DC/DC converter circuit (illustrated as dashed box 158). The PFC circuit 152 may be in electrical communication with the power source 116 and configured to minimize losses in power factor resulting from the charging of the battery. Broadly speaking, a PFC circuit 152 generally may include an AC/DC converter circuit 154 to convert the input AC signal to a DC signal and a boost converter circuit 156, connected in series to the AC/DC converter, to boost the voltage of the input DC signal to a higher voltage while stepping down the current. In one implementation, the AC/DC converter 154 may be a bridge rectifier circuit, although other converter configurations or circuits may also be used. A PFC capacitor 159 may be in electrical communication between an output of the boost converter 156 and a ground or common. The PFC circuit 152 may include more components than the AC/DC converter 154, boost converter 156, and PFC capacitor 159, although such components are not discussed herein.

In addition to the PFC circuit 152, the power supply 102 may include a DC/DC converter circuit 158. The DC/DC converter circuit 158 is configured to modify the voltage of a DC input signal to a higher or lower output DC voltage to meet the demands of the charge signal generating system 106 to charge the battery 104. Such DC/DC converter circuits may include a boost converter, a buck converter, a buck-boost converter, a flyback converter, and the like. In the example illustrated in FIG. 2, the DC/DC converter 158 comprises a flyback converter, although other configurations are contemplated. The DC/DC converter 158 may include a first inductor 162 receiving the output of the PFC circuit 152 on a first end. A switching device 160, such as a transistor or other controllable switch, may connect a second end of the first inductor 162 to a ground or common connection and is controllable to generate a current through the first inductor through a switching mechanism and to regulate voltage on bus 120. For example, when the transistor 160 is open, current may not flow through the first inductor 162. However, when the transistor 160 is closed, current may flow through the first inductor 162. A second inductor 164 may be located near the first inductor 162, that in some instances may form a transformer. A first end of the second inductor 164 may be connected to a diode 166 to ensure the output of the DC/DC converter 158 remains as a DC signal. A DC/DC converter capacitor 168 may be connected between the diode 166 and a second end of the second inductor 164 to form the flyback converter circuit.

The output of the DC/DC converter 158 may provide the DC power signal to the energy bus 120 for use by the charge signal generating system 106 for shaping the charge signal used in charging of the battery 104. As mentioned above with respect to FIG. 1, a storage capacitor 118 may be connected between the energy bus 120 and a common connection. The PFC 152 and DC/DC converter 158 comprise some portions of the power supply 102. In some implementations, the power supply 102 may include more or fewer components, circuits, systems, etc. The circuit 150 may also include additional components not specifically illustrated. For example, while not shown, the circuit 150 may further include a battery measurement circuit to obtain information about the battery 104, as described above with respect to FIG. 1.

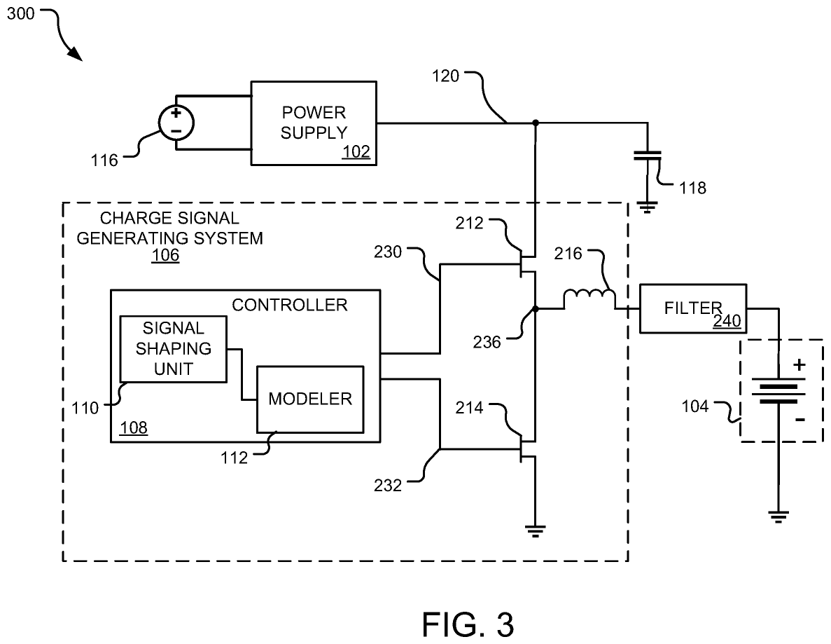

Turning now to FIG. 3, an alternate schematic diagram of a charge signal circuit 300 that illustrates the components, circuits, systems, and the like of the charge signal generating system 106 is illustrated. The circuit 300 includes elements described above with reference to FIGS. 1 and 2, including the power source 116, the power supply 102, the storage capacitor 118, and battery 104. The circuit 300 of FIG. 3, however, expands the charge signal generating system 106 discussed above to illustrate the components and operation of the system. Thus, the power source 116 may provide energy to the power supply 102. The controller 108 may receive the energy and, along with other components of the circuit 300, may generate a shaped charge signal. Further, although not illustrated, the charge signal generated by charge signal generating system 106 for the battery 104 may be based on feedback measurements of the battery obtained by the battery measurement circuit 114. As such, the circuit 300 may include battery measurement circuit 114 as described above with relation to FIG. 1.

In the circuit 300 shown in FIG. 3, the charge signal generating system 106 may include a first switching element, e.g., transistor 212, and a second switching element, e.g., transistor 214, connected in series to the energy bus 120. The first transistor 212 may receive an input signal, such as pulse-width modulation (PWM) control signal 230, from controller 108 to operate the first transistor 212 as a switching device or component. In general, the first transistor 212 may be any type of a transistor, e.g., a FET, or any type of controllable switching element for controllably connecting a first inductor 216 to the bus 120. For example, the first transistor 212 may be a FET with a drain node connected to an inductor 216 at node 236, a source connected to the energy bus 120, and a gate receiving the control signal 230 from the circuit controller 108. The control signal 230 may be provided by the circuit controller 108 to control the operation of the first transistor 212 as a switch that, when closed, connects the first inductor 216 to the energy bus 120 such that the input charge signal from the power supply flows through the inductor 216. In more detail, operation of the switch 212 produces a controlled sequence of pulses at node 236, which are shaped by one or more of inductor 216 and filter 240 to produce a shaped charge signal to the battery 104. In various arrangements, the second transistor 214 may be replaced by a diode. As such, a controlled pulse train to the shaping components 216 etc., may be produced by one or more switches (e.g., transistors). The second transistor 214 may also include a gate configured to receive a second input signal 232 from the controller 108 (e.g., via the signal shaping unit 110) and may have a source that is connected to the drain of the first transistor 212 at node 236. In some instances, the second input signal 232 may be a PWM signal opposite of the first control signal 230 to the first transistor 212. Thus, when the first transistor 212 is closed to connect the inductor 216 to the power supply 102, the second transistor 214 is open. When the first transistor 212 is open, conversely, the second transistor 214 is closed, connecting node 236 and the inductor 216 to ground. Although the first control signal 230 and the second control signal 232 are described herein as opposing signals to control the transistors into opposing states, other techniques for controlling the switching elements 212, 214 may also be implemented with the circuit 300. The inductor value, the time and frequency of actuating the transistors, and other factors can be tailored to generate a waveform and particularly a waveform with controlled harmonics to the battery 104 for charging the same. In some instances, the controller 108 may utilize a model (described in further detail below) of some or all of the circuit 300 to generate the control signals 230, 232, although use of the model is not required to generate the shaped charge signal for charging or discharging the battery 104.

In addition to the first inductor 216, other components may be included in the circuit 300, collectively referred to as a “filter” 240 portion of the circuit. For example, the filter 240 may include a second capacitor connected between the inductor 216 and ground. A second inductor may be connected between the second capacitor and an anode of the battery cell 104. Other combinations and configurations of capacitors, inductors, or other circuit components may be included in the filter 240 portion of the charge circuit 300. The filter 240 of the circuit 300 may operate, in general, to prevent rapid changes to the charge signal applied to the battery cell 104. For example, upon closing of the first transistor 212 based on control signal 230, the inductor 216 and filter 240 may prevent a rapid increase in current transmitted to the battery cell 104. Such rapid increase in current may damage the battery cell 104 or otherwise be detrimental to the life of the battery cell. Moreover, the inductor 216 may shape the waveform applied to the battery, and control of the signal applied to the inductor may provide for controlled shaping of the waveform. Other advantages for charging of the battery cell 104 are also realized through filter circuit 240, but are not discussed herein for brevity.

It should be appreciated that more or fewer components may be included in charge circuit 300. In particular, the circuit 300 of FIG. 3 is but one example of a battery cell charging circuit 300 and the techniques described herein for utilizing a circuit model for generating or otherwise determining control signals 230, 232 for shaping a charge signal may apply to any number of battery cell charging circuits. Further, the circuit 300 includes components arranged similar to a buck converter circuit. However, it should be appreciated that other converter circuits, such as boost circuits, may also be used. Some examples of a charge signal shaping circuit and operation of such are described in greater detail in co-filed U.S. Nonprovisional patent application Ser. No. 17/232,975 titled “Systems And Methods For Battery Charging” and filed on Apr. 16, 2021, the entirety of which is incorporated by reference herein.

Through control of the first transistor 212 and the second transistor 214, the circuit controller 108 may generate a shaped charge signal for efficient charging of the battery 104. In one example, a measured or calculated impedance of the battery 104 or signal definitions characterized from understanding impedance effects of signals on a battery may be used by the circuit controller 108 to generate a charge signal with attributes that correspond to a harmonic associated with a minimum impedance value of the battery 104. As such, the circuit controller 108 may execute a charge signal algorithm that outputs a charge signal shape based on measured, characterized and/or estimated charging conditions of the battery 104. The circuit controller 108 may then generate one or more control signals 230, 232 based on the charge signal algorithm and provide those control signals to one or more switching elements (e.g., the first transistor 212 and the second transistor 214). The control signals 230, 232 may, among other functions, cause operation of switching elements such that the charge signal received from the power supply 102 is shaped to approximate the shaped charge signal determined by the algorithm.

In various aspects, a charge signal defined by the charging algorithm running on the controller 108 may include a shaped leading edge, a body portion, and a rest portion. In one implementation, the shape of the leading edge may be that of a sinusoid (portion thereof) at a frequency selected based on battery characteristics, such as a relatively low impedance harmonic frequency, minimal plating, combinations thereof, or otherwise. In other implementations, the leading edge may comprise a piecewise linear approximation to the selected frequency based on battery characteristics, such as a relatively low impedance harmonic frequency, minimal plating, combinations thereof, or otherwise. The shaped leading edge is followed by a relatively steady charge current (e.g., the body portion) terminating at a falling edge. The body portion is then followed by a rest period. The rest period may be zero current or may be some non-zero DC current less than the substantially DC current of the body portion. The peak current of the body portion may be in the range of the battery specification's maximum rated current to multiples of that maximum rated current, depending on the type of cell with the rest current in the range of 0 A to the maximum rated current. In a specific example, the peak current of the body portion may be in the range of 10 A to 60 A depending on the type of cell with the rest current in the range of 0 A to 10 A. Values for peak current, rest current, and other values may vary, as noted elsewhere herein, depending on temperature, the type of cell, circuit capabilities, state of charge, and other battery-related factors. Further, the shaped leading edge may be formed of linear segments, the collection of which approximate sinusoidal the leading edge. In such an arrangement, a first linear segment increases voltage relatively slowly as compared to a square pulse, for example, where there is an immediate sharp increase in voltage, about 90 degrees. The following linear segments are linear approximations of the shaped-leading edge, which is included/retained in the first charge signal period for comparison and not-included in the second charge signal period.

In some instances, the circuit 300 may utilize a circuit modeler 112 of the circuit 300 to model the circuit or portions of the circuit to estimate the charge signal at the output of the inductor 216 or filter 240 for application to the conductor of the battery cell 104. In some instances, the circuit modeler 112 may model the components external to the circuit controller 108, such as power supply 102, first transistor 212, second transistor 214, inductor 216, and filter circuit 240, to estimate a current waveform at the battery cell 104. The components included in the circuit model may have varying attributes based on the effect of the component on an applied charge signal. For example, the model may include an inductance and an equivalent series resistance value associated with the inductor 216. Other modeled components, such as the switches 212, 214 and/or the battery cell 104 may also include various attributes to improve the accuracy of a simulation performed on the modeled components. Further, the attributes of the modeled components may be adjusted over time based on performance data or feedback data from the circuit components. In some embodiments, feedback data may be provided to the controller 108 and/or model 112. Some examples of a charge signal shaping circuit utilizing a model of the circuit are described in greater detail in co-filed U.S. Nonprovisional patent application Ser. No. 17/566,535 titled “Systems And Methods For Battery Charging Using Circuit Modeling” and filed on Dec. 30, 2021, the entirety of which is incorporated by reference herein.

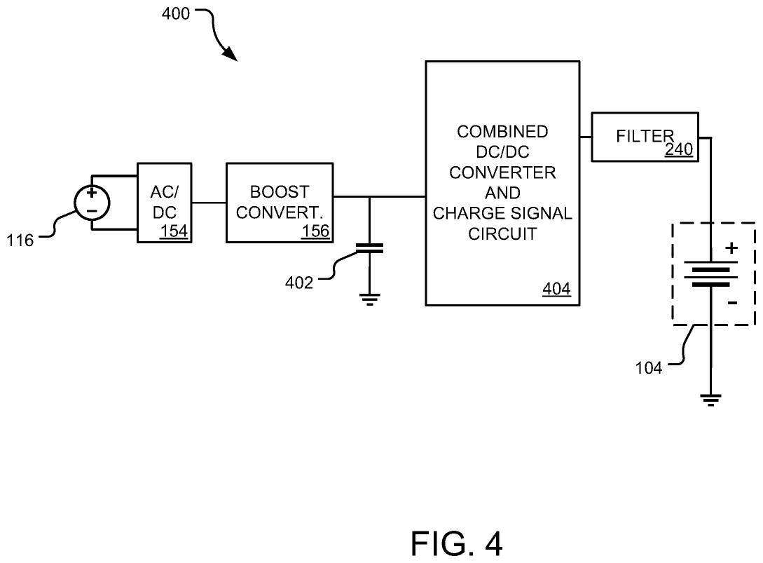

Circuits configured for rapid recharging of a battery 104 typically include costly, high-power electronics for the delivery of high levels of charging current and/or voltage. Thus, reducing the number of components in a charging circuit, or otherwise optimizing such a circuit, may significantly reduce the cost for producing and operating a charger. FIG. 4 illustrates a first schematic diagram of a charging circuit 400 with a combined DC/DC converter and charge signal circuit 404 that reduces the number of electronic components included in the charge circuit 400 while providing the same shaped signal charging functionality as described above with respect to FIGS. 1-3. The combined DC/DC converter and charge signal circuit 404 leverages common components of power supply 102 and the charge signal generating system 106 discussed above to reduce the total number of components of the circuit and to otherwise optimize the configuration of the charge circuit. In particular, the DC/DC converter portion 158 (FIG. 2) of the power supply 102 may be combined with one or more components of the charge signal generating system 106 (FIG. 3). In some embodiments, the capacitor 168 in the DC/DC converter 158 (FIG. 2) may be combined with storage capacitor 118. Additionally or alternatively, the PFC capacitor 159 (FIG. 2) and storage capacitor 118 (FIGS. 1-3) of the previous circuit may be combined into a combined capacitor 402, further reducing the number of components of the charge circuit. Thus, in this implementation, a power factor correction of the energy signal provided by the power source 116 may still be provided by the circuit 400, while the DC/DC converter portion of the power supply is combined with components of the charge signal generating system 106 to reduce the overall components used in the circuit. The output of the combined DC/DC converter and charge signal circuit 404 may or may not be provided to a filter 240 as discussed above for use in charging or discharging battery 104. In this manner, an optimized circuit 400 for charging or discharging the battery 104 may utilize the various functions and/or components of the power supply 102 to reduce the total number of components of the circuit.

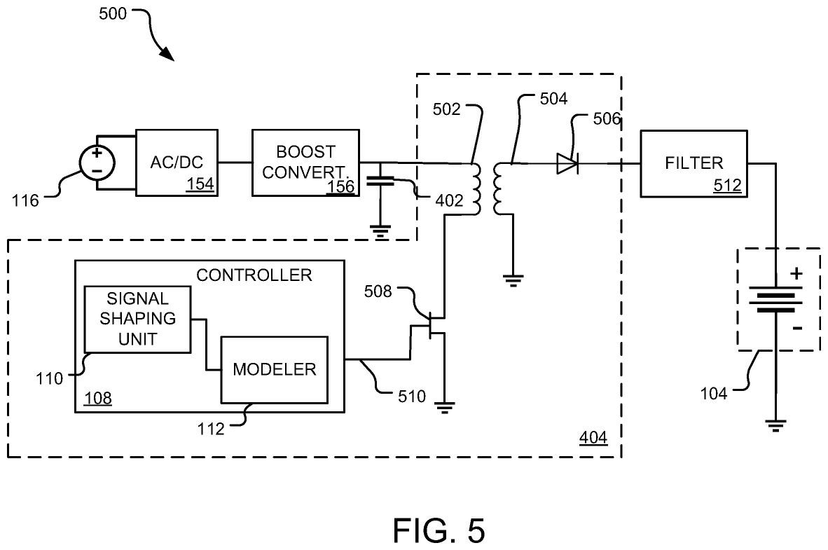

FIG. 5 is a second, more detailed schematic diagram of a charging circuit 500 with a combined converter and charge signal circuit 404. In particular, the charging circuit 500 of FIG. 5 illustrates the components of the combined DC/DC converter and charge signal generating circuit 404 discussed above with reference to FIG. 4 and includes many of the same components discussed above. In particular, the optimized circuit 500 may include a power source 116 providing an AC power signal to an AC/DC converter 154. The AC/DC converter 154 may transform the AC power signal to a DC power signal and provide the DC power signal to a boost converter 156. The boost converter 156 may boost the input DC power signal and provide the boosted DC signal to the combined PFC/storage capacitor 402. As mentioned above, combined PFC/storage capacitor 402 may perform the energy storage and delivery functions of the PFC capacitor 159 and storage capacitor 118 of the circuit 150 of FIG. 2 described above. Through these components, the optimized circuit 500 may maintain the power factor correction function of the charge circuit while reducing the number of components needed for the charge circuit.

The optimized circuit 500 may also include a combined DC/DC converter and charge signal generation circuit 404 (similar to that shown in FIG. 4) that reduces the number of components used in the circuit by combining the functionality of the DC/DC converter 158 of the power supply 102 with the charge signal generating system 106. In particular, the charge signal generating system 106 discussed above with relation to FIG. 3 comprises a buck converter circuit in which the first transistor 212 and the second transistor 214 are controlled by the control signals 230, 232 generated by controller 108 to shape the charge signal. In other implementations of the charge circuit, the charge signal generating system 106 may comprise a boost converter circuit, a flyback converter circuit, or any other DC/DC converter circuit. Similarly, the DC/DC converter 158 of the power supply 102 discussed above with relation to FIGS. 1 and 2 may also comprise a boost converter circuit, a buck converter circuit, a flyback converter circuit, or a combination of such circuits. Thus, both the DC/DC converter 158 and the charge signal generating system 106 may include similar components, configurations, and functionalities related to the converter circuit. The similar operations and functions of the DC/DC converter 158 and charge signal generating system 106 may be combined, in some instances, to reduce the number of components and optimize the overall charge circuit design to minimize cost and complexity of the charge circuit.

As shown in FIG. 5, the combined DC/DC converter and charge signal generating system may include a transistor 508 or other switching-type devices. The transistor 508 may receive the control signal 510 from the circuit controller 108, as described above with reference to the circuit 300 of FIG. 3. The circuit controller 108 may include a signal shaping unit 110 and, in some implementations, a circuit modeler 112 to maintain a model of one or more of the components of the charge circuit. The operation of the controller 108 may be similar to that described above in that the controller may utilize the signal shaping unit 110 and/or modeler 112 to generate a control signal 510 to the transistor 508 or other switching device for charging or discharging the battery 104. In some embodiments, the circuit controller 108 may generate the pulse-width modulation (PWM) control signal discussed above. Such a control signal 510 may control the flow of current through a first inductor 502 receiving the output of the boost converter 156. The operation of the transistor 508 by the controller 108 to alternate between an open state and a closed state may generate or modulate a current through the first inductor 502. The current through the first inductor 502 may, in turn, generate a corresponding varying current in a second inductor 504 located near the first inductor such that the first inductor and the second inductor may form a transformer device. A first end of the second inductor 504 may be connected to a diode 506, the output of which may be connected to a filter circuit 512 comprising any number of components to filter out particular frequencies from the charge signal generated by the second inductor. In some instances, the diode 506 may be a bridge rectifier circuit or other type of rectifier for instances in which the circuit is used to discharge the battery 104. In general, however, the filtered charge signal as shaped by the controller 108 and optional filter 512 may be used to charge the battery 104.

In some instances, the first inductor 502 and the second inductor 504 may be a transformer device with a turns ratio between the first inductor and the second inductor, rather than separate inductor devices. The turns ratio of the transformer may configure the charge circuit as a boost circuit or a buck circuit. For example, a higher turns ratio of the first inductor 502 in relation to the second inductor 504 may step down the DC signal output by the second inductor, configuring the circuit 500 as a buck charging circuit for charging the battery cell 104. Alternatively, a lower turns ratio of the first inductor 502 in relation to the second inductor 504 may step up the DC signal output by the second inductor, configuring the circuit 500 as a boost circuit for charging the battery cell 104. In this manner, the first inductor 502 and the second inductor 504 may be selected with a particular turns ratio to configure the charge circuit 500 as a buck or boost circuit or any combination therein.

The charge circuit 500 of FIG. 5 is an optimized circuit in comparison to previously discussed charge circuits, such as charge circuit 150 of FIG. 2, through the combination of similar circuits, components, and functions. For example, in some embodiments, capacitor 168 and storage capacitor 118 may be consolidated into a single combined capacitor. In some embodiments, PFC capacitor 159 and storage capacitor 118 discussed above with relation to FIG. 2 may be combined into a combined capacitor 402 of FIGS. 4 and 5, reducing the total number of capacitors in the reduced charge circuit. As mentioned above, one or more components of the charge circuit may be rated as high-power electronics for the delivery of high levels of charging current, which may be costly. Thus, reducing the number of high-power capacitors or other expensive components of the charge circuit 500 may reduce both the footprint and the overall cost of the circuit. Additionally, the function of the DC/DC converter 158 of the power supply 102 of FIG. 2 and portions of the charge signal generating system 106 may both operate to increase a DC input signal to an output DC signal, while stepping down the current through a boost converter, a buck converter, a buck-boost converter, a flyback converter, and the like. Thus, the components of the charge signal generating system 106 may be repurposed as a combined DC/DC converter, further reducing the number of components included in the charge circuit 500. In particular and as shown in FIG. 5, the flyback converter circuit configuration connected to the circuit controller 108 of charge circuit 500 may provide the dual DC/DC conversion and charge signal shaping functionalities of the charge circuit 500 through fewer components than in previous circuit configurations. In this manner, several circuit components may be removed and similar or redundant functionalities of the components may be utilized to provide the dual DC/DC conversion and charge signal shaping functionalities of the charge circuit 500 with fewer overall devices included in the circuit. Such reduction in components and complexity may reduce the overall footprint, conserve charging energy lost to the redundant components, and reduce the cost of the charge circuit 500.

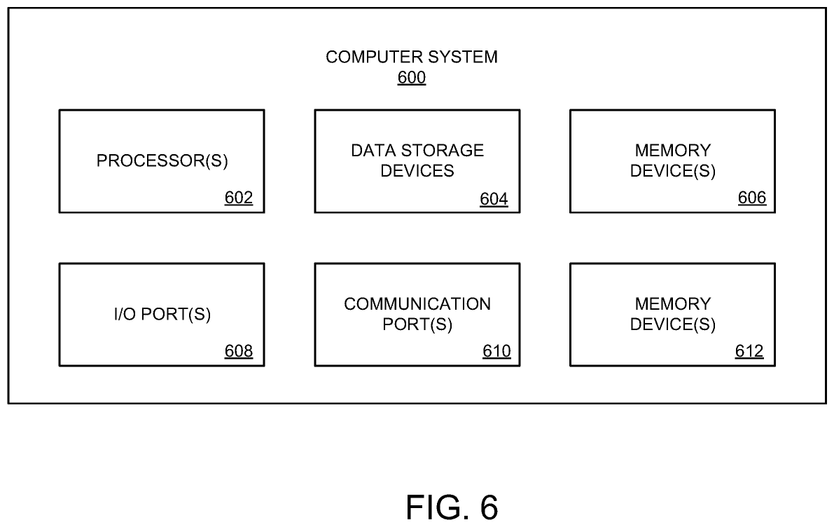

Referring now to FIG. 6, a detailed description of an example computing system 600 having one or more computing units that may implement various systems and methods discussed herein is provided. The computing system 600 may be part of a controller, may be in operable communication with various implementation discussed herein, may run various operations related to the method discussed herein, may run offline to process various data for characterizing a battery, and may be part of overall systems discussed herein. The computing system 600 may process various signals discussed herein and/or may provide various signals discussed herein. For example, battery measurement information may be provided to such a computing system 600. The computing system 600 may also be applicable to, for example, the controller 108, the modeler 112, and the tuning/shaping circuits discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 600 may be a computing system that is capable of executing a computer program product to execute a computer process. Data and program files may be input to the computer system 600, which reads the files and executes the programs therein. Some of the elements of the computer system 600 are shown in FIG. 6, including one or more hardware processors 602, one or more data storage devices 604, one or more memory devices 606, and/or one or more ports 608-612. Additionally, other elements that will be recognized by those skilled in the art may be included in the computing system 600 but are not explicitly depicted in FIG. 6 or discussed further herein. Various elements of the computer system 600 may communicate with one another by way of one or more communication buses, point-to-point communication paths, or other communication means not explicitly depicted in FIG. 6. Similarly, in various implementations, various elements disclosed in the system may or not be included in any given implementation.

The processor 602 may include, for example, a central processing unit (CPU), a microprocessor, a microcontroller, a digital signal processor (DSP), and/or one or more internal levels of cache. There may be one or more processors 602, such that the processor 602 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 604, stored on the memory device(s) 606, and/or communicated via one or more of the ports 608-612, thereby transforming the computer system 600 in FIG. 6 to a special purpose machine for implementing the operations described herein.

The one or more data storage devices 604 may include any non-volatile data storage device capable of storing data generated or employed within the computing system 600, such as computer executable instructions for performing a computer process, which may include instructions of both application programs and an operating system (OS) that manages the various components of the computing system 600. The data storage devices 604 may include, without limitation, removable data storage media, non-removable data storage media, and/or external storage devices made available via a wired or wireless network architecture with such computer program products, including one or more database management products, web server products, application server products, and/or other additional software components. The one or more memory devices 606 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 604 and/or the memory devices 606, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 600 includes one or more ports, such as an input/output (I/O) port 608, a communication port 610, and a sub-systems port 612, for communicating with other computing, network, or vehicle devices. It will be appreciated that the ports 608-612 may be combined or separate and that more or fewer ports may be included in the computer system 600. The I/O port 608 may be connected to an I/O device, or other device, by which information is input to or output from the computing system 600. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 600 via the I/O port 608. In some examples, such inputs may be distinct from the various system and method discussed with regard to the preceding figures. Similarly, the output devices may convert electrical signals received from computing system 600 via the I/O port 608 into signals that may be sensed or used by the various methods and system discussed herein. The input device may be an alphanumeric input device, including alphanumeric and other keys for communicating information and/or command selections to the processor 602 via the I/O port 608.

The environment transducer devices convert one form of energy or signal into another for input into or output from the computing system 600 via the I/O port 608. For example, an electrical signal generated within the computing system 600 may be converted to another type of signal, and/or vice-versa. In one implementation, the environment transducer devices sense characteristics or aspects of an environment local to or remote from the computing device 600, such as battery voltage, open circuit battery voltage, charge current, battery temperature, light, sound, temperature, pressure, magnetic field, electric field, chemical properties, and/or the like.

In one implementation, a communication port 610 may be connected to a network by way of which the computer system 600 may receive data useful in executing the methods and systems set out herein as well as transmitting information. For example, charging protocols may be updated, battery measurement or calculation data shared with external system, and the like may be communicated via the communication port 610. The communication port 610 connects the computer system 600 to one or more communication interface devices configured to transmit and/or receive information between the computing system 600 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 610 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

The computer system 600 may include a sub-systems port 612 for communicating with one or more systems related to a device being charged according to the methods and system described herein to control an operation of the same and/or exchange information between the computer system 600 and one or more sub-systems of the device. Examples of such sub-systems of a vehicle, include, without limitation, motor controllers and systems, battery control systems, and others.

The system set forth in FIG. 6 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

We claim:

1. A system for charging a battery comprising:
a power supply circuit comprising a converter portion receiving a power signal, the power supply circuit further comprising a voltage booster portion;
a storage capacitor in operable communication with an output of the booster portion of the power supply circuit, the storage capacitor and power supply circuit correcting for a power factor loss of the power signal during charging of an electrochemical device; and
a combined direct current/direct current (DC/DC) converter and charge waveform shaping circuit to alter a DC signal from the booster portion to a shaped charge waveform for charging the electrochemical device.

2. The system of claim 1 wherein the power signal is an alternating current (AC) power signal and the converter portion of the power supply circuit converts the power signal from the AC power signal to a direct current (DC) power signal and wherein the voltage booster portion increases a magnitude of the DC power signal.

3. The system of claim 1 wherein the shaped charge waveform comprises a non-linear leading edge and a body portion comprising a first non-sinusoidal charge current following the non-linear leading edge.

4. The system of claim 1 wherein the combined DC/DC converter and charge waveform shaping circuit comprises:
a transformer in operable communication with the power supply circuit to receive the power signal;
a switch in operable communication with the transformer; and
a processor in communication with the switch and configured to execute instructions to control the switch to generate a sequence of pulses at the transformer to produce the shaped charge waveform.

5. The system of claim 4 wherein the storage capacitor provides stored energy to the combined DC/DC converter and charge waveform shaping circuit in addition to correcting for the power loss factor.

6. The system of claim 4 wherein the processor is in communication with a model of the transformer and further configured to control the switch responsive to running the model.

7. The system of claim 1 wherein the combined DC/DC converter and charge waveform shaping circuit comprises a buck circuit and converting the DC signal to the shaped charge waveform comprises decreasing a voltage of the DC signal.

8. The system of claim 1 wherein the combined DC/DC converter and charge waveform shaping circuit comprises a flyback circuit.

9. The system of claim 1, further comprising:
a filter in operable communication with an output of the combined DC/DC converter and charge waveform shaping circuit, the filter removing noise components of the shaped charge waveform.

10. The system of claim 4, further comprising:
a diode in operable communication with an output of the transformer to provide the shaped charge waveform as a DC signal.

11. A method for charging a battery, the method comprising:
correcting, at a power supply circuit, a power factor of an alternating current (AC) component of an input power signal;
converting, at the power supply circuit, the AC component of the input power signal into a direct current (DC) power signal; and
controlling a switch in communication with a processor executing instructions to generate a control signal, the switch operable connected to a transformer to receive and alter the DC power signal to produce a shaped charge waveform to charge an electrochemical device.

12. The method of claim 11, further comprising:
filtering the shaped charge waveform from the transformer to remove noise components of the shaped charge waveform.

13. The method of claim 11, wherein the control signal comprises a pulse-width modulated (PWM) signal to alternately open and close the switch to transmit the DC power signal to the transformer to produce the shaped charge waveform.

14. The method of claim 11 wherein the instructions to control the switch to produce the shaped charge waveform to charge an electrochemical device is further based on a model of the transformer.

15. The method of claim 11 further comprising:
increasing, via a boost circuit in communication with the power supply circuit, a voltage of the DC power signal and wherein the transformer and the switch comprise a portion of the boost circuit.

16. The method of claim 11 further comprising:
decreasing, via a buck circuit in communication with the power supply circuit, a voltage of the DC power signal, wherein the transformer and the switch comprise a portion of the buck circuit.

17. A charging circuit comprising:
a power supply converting an alternating current (AC) power signal to a direct current (DC) input signal;
a transformer comprising a first end in electrical communication with the power supply and receiving the DC input signal;
a switch in electrical communication with a second end of the transformer; and
a processor executing instructions to control the switch to pull the DC input signal through the transformer, wherein an output of the transformer provides a shaped charge waveform to charge an electrochemical device based on the control of the switch.

18. The charging circuit of claim 17, wherein executing the instructions causes the processor to transmit a sequence of pulse width modulated signals to the switch to alternately open and close the switch to transmit the DC input signal to the transformer to produce the shaped charge waveform output from the transformer.

19. The charging circuit of claim 17, wherein the power supply further comprises a power factor correcting circuit comprising a storage capacitor and a boost converter circuit to increase a voltage of the DC input signal.

20. The charging circuit of claim 17 wherein the switch comprises a transistor comprising a first interface connected to the processor to receive control signals from the processor and a second interface connected to the transformer, wherein the control signals comprise a pulse-width modulated signal that generates a sequence of pulses at the transformer via the transistor.
